(19) United States
(12) Patent Application Publication
(10) Pub. No.: US 2006/0139242 A1
(43) Pub. Date: Jun. 29, 2006

(54) Plasma display apparatus and driving apparatus of plasma display panel

(75) Inventors: Byung Nam Ahn, Seoul (KR); Tae Heon Kim, Seoul (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/296,356

(22) Filed: Dec. 8, 2005

(30) Foreign Application Priority Data
Dec. 9, 2004 (KR) 10-2004-0103845

(51) Int. Cl. G09G 3/28

(52) U.S. Cl. 345/60

(57) ABSTRACT

The present invention relates to a plasma display apparatus and a driving apparatus of a plasma display panel. The plasma display apparatus and the driving apparatus of the plasma display panel according to the present invention comprises an energy storage unit connected to a voltage source that supplies a reference voltage, for supplying or recovering energy. The present invention can prohibit circuit loss and can enhance an energy recovery ratio by improving an energy recovery circuit of a sustain driver.

### CROSS-REFERENCE TO RELATED APPLICATIONS

This Nonprovisional application claims priority under 35 U.S.C. §119(a) on Patent Application No. 2004-0103845 filed in Korea on Dec. 09, 2004 the entire contents of which are hereby incorporated by reference.

### BACKGROUND OF THE INVENTION

1. Field of the Invention

The present invention relates to a plasma display apparatus and a driving apparatus of a plasma display panel.

2. Background of the Related Art

In a plasma display panel of the related art, barrier ribs formed between a front substrate and a rear substrate form cells. Each cell is filled with an inert gas. The inert gas comprises a primary discharge gas, such as neon (Ne), helium (He) or a mixed gas of Ne+He and a small amount of xenon (Xe). When a discharge is generated by a high frequency voltage, vacuum ultraviolet rays generated by the inert gas light-emit phosphors formed between the barrier ribs.

FIG. 1 schematically shows the construction of a plasma display apparatus in the related art. As shown in FIG. 1, the plasma display apparatus of the related art comprises a casing 110 comprising a front cabinet 111 and a back cover 112, a plasma display panel 120 mounted in the casing 110, a driving apparatus 130 for driving the plasma display panel 120, and a frame 140 coupled to the driving apparatus 130, for radiating heat generating when the plasma display panel is driven and supporting the plasma display panel.

The related art plasma display apparatus further comprises a filter 150 whose film is attached to a transparent glass substrate (not shown), a filter spring gasket 160 and a filter supporter 170, which support the filter 150 and are electrically connected to the back cover 112, and a module supporter 180 for supporting the driving apparatus 130 and the plasma display panel 120.

Meanwhile, the driving apparatus 130 of the plasma display panel 120 alternately applies a sustain voltage (Vs) to a scan electrode and a sustain electrode in order to sustain a discharge of a cell selected in a sustain period.

The driving apparatus 130 of the plasma display panel in the related art comprises a scan electrode driver and a sustain electrode driver. Each of the scan electrode driver and the sustain electrode driver comprises an energy recovery circuit.

FIG. 2a is a circuit diagram of the energy recovery circuit included in the driving apparatus of the plasma display panel in the related art. FIG. 2b shows a waveform of a sustain pulse generated by the energy recovery circuit shown in FIG. 2a. As shown in FIGS. 2a and 2b, the related art energy recovery circuit is adapted to recover reactive power.

In a first state (State1), a first switch Q1 is turned on and second to fourth switches Q2, Q3 and Q4 are turned off. Therefore, energy stored in a capacitor Css is supplied to a capacitance component Cp of the plasma display panel through resonance between an inductor L and the capacitance component Cp of the plasma display panel. Therefore, a voltage (Vp) of the scan electrode or the sustain electrode rises up to a sustain voltage (Vs). The sustain voltage (Vs) is a voltage for sustaining the discharge of a discharge cell. The current flowing through the inductor L becomes +IL because energy is supplied from the capacitor Css to the capacitance component Cp of the plasma display panel.

In a second state (State2), the first switch Q1 and the second switch Q2 are turned on and the third switch Q3 and the fourth switch Q4 are turned off. Therefore, the voltage (Vp) of the scan electrode or the sustain electrode is kept to the sustain voltage (Vs).

In a third state (State3), the third switch Q3 is turned on, and the first switch Q1, the second switch Q2 and the fourth switch Q4 are turned off. Therefore, the energy stored in the capacitance component Cp of the plasma display panel is recovered through resonance between the inductor L and the capacitance component Cp of the plasma display panel while being discharged to the capacitor Css. Therefore, the voltage (Vp) of the scan electrode or the sustain electrode drops to a voltage of a ground level. In the third state, the current flowing through the inductor L becomes −IL because the current flows from the capacitance component Cp of the plasma display panel to the capacitor Css.

In a fourth state (State4), the third switch Q3 and the fourth switch Q4 are turned on and the first switch Q1 and the second switch Q2 are turned off. Therefore, the voltage (Vp) of the scan electrode and the sustain electrode is kept to a voltage of a ground level.

FIGS. 3a and 3b show a current loop of the energy recovery circuit in the related art. As shown in FIG. 3a, in the first state (State1) of FIG. 2b, the current (+IL) flowing through the inductor L is formed by resonance between the inductor L and the plasma display panel. The resonance current (+IL) passes through the capacitance component Cp of the plasma display panel and then flowing through the ground voltage source GND.

Furthermore, as shown in FIG. 3b, in the third state (State3) of FIG. 2b, the current (−IL) flowing through the inductor L is formed by the resonance between the inductor L and the capacitance component Cp of the plasma display panel. The resonance current (−IL) passes through the ground voltage source GND to the capacitance component Cp of the plasma display panel and the capacitor. Css.

The frame 140 shown in FIG. 1 plays the role of the ground voltage source GND shown in FIGS. 3a and 3b.

FIG. 4a is a circuit diagram of an energy recovery circuit that generates a negative sustain pulse in the related art. FIG. 4b shows a waveform of the negative sustain pulse generated by the energy recovery circuit shown in FIG. 4a.

A supply/recovery capacitor Css of FIG. 4a stores or radiates energy necessary for a sustain discharge. The electrostatic capacity of the supply/recovery capacitor Css is −Vs/2 where Vs is a sustain voltage.

As the first switch Q1 is turned on, energy stored in the supply/recovery capacitor Css is supplied to the capacitance component Cp of the plasma display panel.

As the second switch Q2 is turned on, the voltage of the capacitance component Cp of the plasma display panel is kept to a negative sustain voltage (−Vs).

As the third switch Q3 is turned on, energy is recovered from the capacitance component Cp of the plasma display panel to the supply/recovery capacitor Css.

As the fourth switch Q4 is turned on, the voltage of the capacitance component Cp of the plasma display panel is kept to the voltage of the ground level.

The inductor. L forms a serial resonance circuit along with the capacitance component Cp of the plasma display panel when energy is supplied as the first switch Q1 is turned on or energy is recovered as the third switch Q3 is turned on.

FIG. 5 shows a current loop of the energy recovery circuit that generates the negative sustain pulse in the related art. As shown in FIG. 5, when the energy stored in the supply/recovery capacitor Css in the first state (State1) of FIG. 4b is supplied to the capacitance component Cp of the plasma display panel, the current flowing through the inductor L flows in an arrow direction of FIG. 5. That is, the current flowing through the inductor L in the first state (State1) of FIG. 4b passes through the capacitance component Cp of the plasma display panel and the negative sustain voltage source (−Vs) through connection of the supply/recovery capacitor Css and the negative sustain voltage source (−Vs).

In the current loop consisting of the capacitance component Cp of the plasma display panel and the negative sustain voltage source (−Vs), the flow of the current is not smooth since the frame 140 of FIG. 1 does not play the role of the ground voltage source GND.

Furthermore, the current loop consisting of the capacitance component Cp of the plasma display panel and the negative sustain voltage source (−Vs) passes through the negative sustain voltage source (−Vs). Therefore, circuit loss, such as induction loss, is generated between a board in which the energy recovery circuit is formed and the leading wire. The energy recovery ratio is low due to the generation of circuit loss.

### SUMMARY OF THE INVENTION

Accordingly, an object of the present invention is to solve at least the problems and disadvantages of the background art.

It is an object of the present invention to provide a driving apparatus of a plasma display panel and a plasma display apparatus, in which circuit loss can be prohibited and the energy recovery ratio can be enhanced.

An driving apparatus of a plasma display panel comprising an electrode according to an embodiment of the present invention comprises an energy storage unit connected to a voltage source that supplies a reference voltage, for supplying or recovering energy corresponding to a negative first voltage, a path forming unit for supplying the energy corresponding to the negative first voltage from the energy storage unit to an electrode through resonance, or for recovering the energy corresponding to the negative first voltage from the electrode to the energy storage unit through resonance, and a voltage application unit for applying a negative second voltage to the electrode after the energy corresponding to the negative first voltage is supplied and for applying the reference voltage to the electrode after the energy corresponding to the negative first voltage is recovered.

A plasma display apparatus according to another embodiment of the present invention comprises a plasma display panel comprising an electrode, an energy storage unit connected to a voltage source that supplies a reference voltage, for supplying or recovering energy corresponding to a negative first voltage, a path forming unit for supplying the energy corresponding to the negative first voltage from the energy storage unit to the plasma display panel through the electrode or for supplying the energy corresponding to the negative first voltage from the plasma display panel to the energy storage unit through the electrode, and a voltage application unit for applying a negative second voltage to the electrode after energy corresponding to the negative first voltage is supplied and for applying the reference voltage to the electrode after energy corresponding to the negative first voltage is recovered.

The present invention is advantageous in that it can prohibit circuit loss and can enhance an energy recovery ratio by improving an energy recovery circuit of a sustain driver.

Furthermore, the present invention can form a smooth current loop by improving an energy recovery circuit of a sustain driver.

### BRIEF DESCRIPTION OF THE DRAWINGS

The invention will be described in detail with reference to the following drawings in which like numerals refer to like elements.

FIG. 1 schematically shows the construction of a plasma display apparatus in the related art;

FIG. 2a is a circuit diagram of an energy recovery circuit included in a driving apparatus of a plasma display panel in the related art;

FIG. 2b shows a waveform of a sustain pulse generated by the energy recovery circuit shown in FIG. 2a;

FIGS. 3a and 3b show a current loop of the energy recovery circuit in the related art;

FIG. 4a is a circuit diagram of an energy recovery circuit that generates a negative sustain pulse in the related art;

FIG. 4b shows a waveform of the negative sustain pulse generated by the energy recovery circuit shown in FIG. 4a;

FIG. 5 shows a current loop of the energy recovery circuit that generates the negative sustain pulse in the related art;

FIG. 6 is a circuit diagram of a plasma display apparatus according to an embodiment of the present invention;

FIG. 7 shows a waveform of a sustain pulse depending on the operation of the plasma display apparatus according to an embodiment of the present invention;

FIG. 8a shows a current loop in a first state of FIG. 7;

FIG. 8b shows a current loop in a third state of FIG. 7;

FIG. 9 shows a current waveform and a voltage waveform in the operation of the plasma display apparatus according to an embodiment of the present invention.

### DETAILED DESCRIPTION OF PREFERRED EMBODIMENTS

Preferred embodiments of the present invention will be described in a more detailed manner with reference to the drawings.

An driving apparatus of a plasma display panel according to an embodiment of the present invention comprises an energy storage unit connected to a voltage source that supplies a reference voltage, for supplying or recovering energy corresponding to a negative first voltage, a path forming unit for supplying the energy corresponding to the negative first voltage from the energy storage unit to an electrode through resonance, or for recovering the energy corresponding to the negative first voltage from the electrode to the energy storage unit through resonance, and a voltage application unit applying a negative second voltage to the electrode after the energy corresponding to the negative first voltage is supplied and for applying the reference voltage to the electrode after the energy corresponding to the negative first voltage is recovered.

The reference voltage is a ground level voltage.

The negative first voltage is half of the negative second voltage.

The negative second voltage is a negative sustain voltage for sustaining a discharge.

The negative first voltage is half of the negative sustain voltage.

The energy storage unit comprises a capacitor for storing the energy. The capacitor has one end connected to the voltage source that supplies the reference voltage, and the other end through which the energy is supplied or recovered.

The negative first voltage is −100V and the negative second voltage is −200V.

A plasma display apparatus according to another embodiment of the present invention comprises a plasma display panel comprising an electrode, an energy storage unit connected to a voltage source that supplies a reference voltage, for supplying or recovering energy corresponding to a negative first voltage, a path forming unit supplying the energy corresponding to the negative first voltage from the energy storage unit to the plasma display panel through the electrode or for supplying the energy corresponding to the negative first voltage from the plasma display panel to the energy storage unit through the electrode, and a voltage application unit for applying a negative second voltage to the electrode after energy corresponding to the negative first voltage is supplied for applying the reference voltage to the electrode after energy corresponding to the negative first voltage is recovered.

The reference voltage is a ground level voltage.

The negative first voltage is half of the negative second voltage.

The negative second voltage is a negative sustain voltage for sustaining a discharge.

The negative first voltage is half of the negative sustain voltage.

The energy storage unit comprises a capacitor for storing the energy. The capacitor has one end connected to the voltage source that supplies the reference voltage, and the other end through which the energy is supplied or recovered.

The negative first voltage is −100V and the negative second voltage is −200V.

The voltage source that supplies the reference voltage is a frame supporting the plasma display panel.

An embodiment of the present invention will be described in detail below with reference to the accompanying drawings.

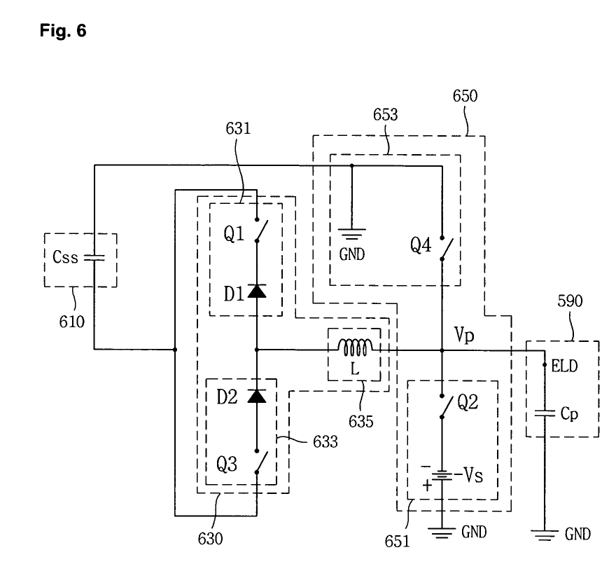

FIG. 6 is a circuit diagram of a plasma display apparatus according to an embodiment of the present invention. As shown in FIG. 6, the plasma display apparatus according to an embodiment of the present invention comprises a plasma display panel 590, an energy storage unit 610, a path forming unit 630 and a voltage application unit 650.

<Plasma Display Panel>

The plasma display panel 590 comprises an electrode ELD for receiving a driving pulse. Capacitance component Cp of FIG. 6 is formed by the electrode of the plasma display panel. The electrode of the plasma display panel 590 functions to receive a sustain pulse for sustaining a discharge in a selected cell in an address period.

<Energy Storage Unit>

The energy storage unit 610 has one end connected to a voltage source for supplying a reference voltage (GND), and the other end from or to which energy corresponding to a negative first voltage (−Vs/2) is output or input. The negative first voltage can be set to be a half of a negative sustain voltage (−Vs). The negative sustain voltage (−Vs) functions to sustain a discharge in a selected cell in an address period. The reference voltage (GND) can be a voltage of a ground level.

The energy storage unit 610 comprises a capacitor Css in which energy corresponding to the negative first voltage (−Vs/2) is stored. The capacitor Css has one end connected to the reference voltage (GND). The input and output of energy corresponding to the negative first voltage (−Vs/2) are carried out through the other end of the capacitor Css.

<Path Forming Unit>

The path forming unit 630 supplies energy corresponding to the negative first voltage (−Vs/2) from the energy storage unit 610 to the plasma display panel 590 via the electrode ELD through resonance, or recovers energy corresponding to the negative first voltage from the plasma display panel 590 to the energy storage unit 610 via the electrode ELD through resonance.

The path forming unit 630 comprises an energy supply controller 631, an energy recovery controller 633 and an inductor unit 635.

The energy supply controller 631 controls energy corresponding to the negative first voltage (−Vs/2) to be supplied from the capacitor Css of the energy storage unit 610 to the plasma display panel 590 through the electrode ELD. The energy supply controller 631 comprises a first switch Q1 and a first diode D1. The first switch Q1 is turned on to supply energy, which is stored in the capacitor Css of the energy storage unit 610, to the capacitance component Cp of the plasma display panel 590. The first diode D1 precludes inverse current, which flows from the capacitance component Cp of the plasma display panel 590 to the capacitor Css through the first switch Q1. The cathode terminal of the first diode D1 is connected to one end of the inductor L included in the inductor unit 630 and the anode terminal thereof is connected to one end of the first switch Q1.

The energy recovery controller 633 controls energy corresponding to the negative first voltage (−Vs/2) to be recovered from the plasma display panel 590 to the energy storage unit 610 through the electrode ELD. The energy recovery controller 633 comprises a third switch Q3 and a second diode D2. The third switch Q3 is turned on so that a voltage component of reactive power is recovered by the capacitor Css of the energy storage unit 610 during a sustain discharge. The second diode D2 precludes inverse current, which flows from the supply/recovery capacitor Css to the panel Cp through the third switch Q3. The anode terminal of the second diode D2 is connected to one end of the inductor L included in the inductor unit 635 and the cathode terminal of the second diode D2 is connected to one end of the third switch Q3.

The inductor unit 635 forms a resonant circuit along with the capacitance component Cp of the plasma display panel 590. Therefore, when energy stored in the energy storage unit 610 is supplied to the capacitance component Cp of the plasma display panel by means of the energy supply controller 631, the capacitance component Cp of the plasma display panel is charged up to the sustain voltage (−Vs) (i.e., a negative second voltage) due to the current supplied via the inductor unit 635.

Furthermore, when energy charged in the capacitance component Cp of the plasma display panel is recovered by the energy storage unit 610 as the third switch Q3 is turned on, the energy storage unit 610 is charged with energy that is recovered from the capacitance component Cp of the plasma display panel through the inductor unit 630.

<Voltage Application Unit>

The voltage application unit 650 applies the negative second voltage (−Vs) to the electrode ELD after energy corresponding to the negative first voltage (−Vs/2) is supplied to the plasma display panel 590 through the electrode ELD, and applies the reference voltage to the electrode ELD after energy corresponding to the negative first voltage (−Vs/2) is recovered from the electrode ELD. The negative second voltage can be the negative sustain voltage (−Vs). The reference voltage can be the ground level voltage (GND).

The voltage application unit 650 comprises a second voltage supply unit 651 and a reference voltage supply unit 653. The second voltage supply unit 651 comprises a second switch Q2. The second switch Q2 has one end connected to the voltage source that supplies the negative second voltage. When the voltage of the capacitance component Cp of the plasma display panel 590 becomes the negative second voltage after energy is supplied from the energy storage unit 610 to the capacitance component Cp of the plasma display panel 590, the second switch Q2 is turned on. As the second switch Q2 is turned on, the voltage of the capacitance component Cp of the plasma display panel 590 is kept to the negative sustain voltage (−Vs).

The reference voltage supply unit 653 comprises a fourth switch Q4. The fourth switch Q4 has one end connected to the voltage source that supplies the reference voltage. When the voltage of the capacitance component Cp of the plasma display panel 590 falls up to the reference voltage after energy is recovered from the capacitance component Cp of the plasma display panel 590, the fourth switch Q4 is turned on. As the fourth switch Q4 is turned on, the voltage of the capacitance component Cp of the plasma display panel 590 is kept to the reference voltage.

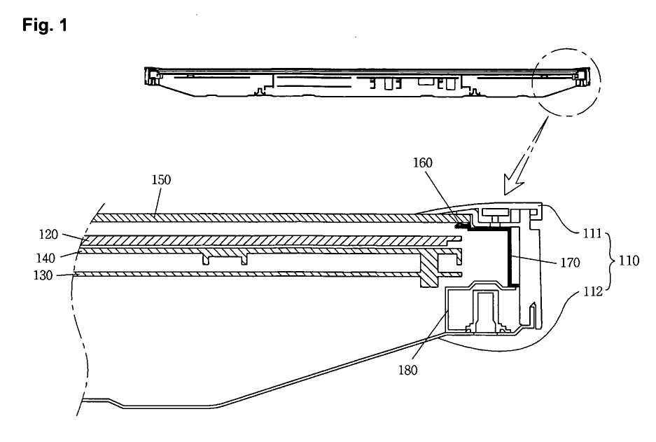

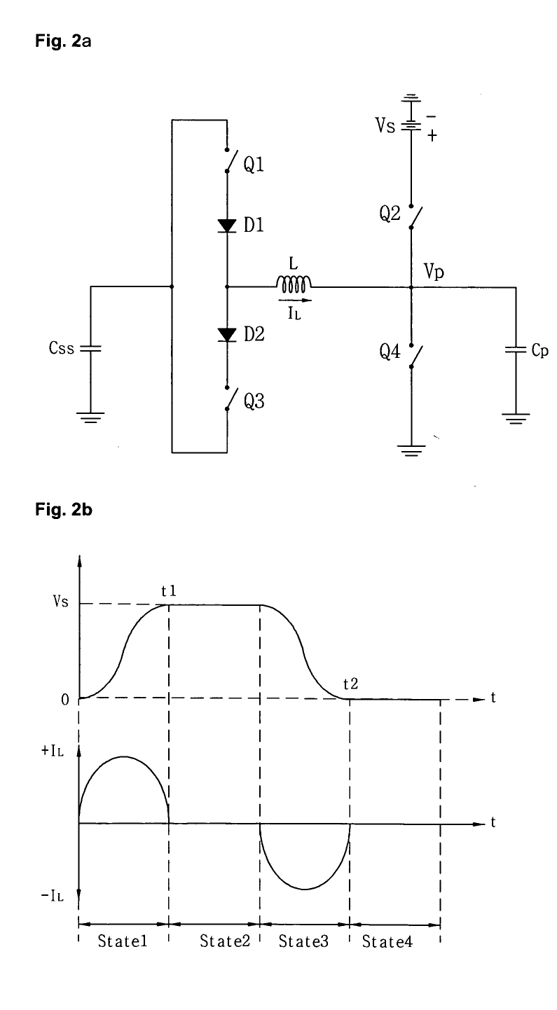

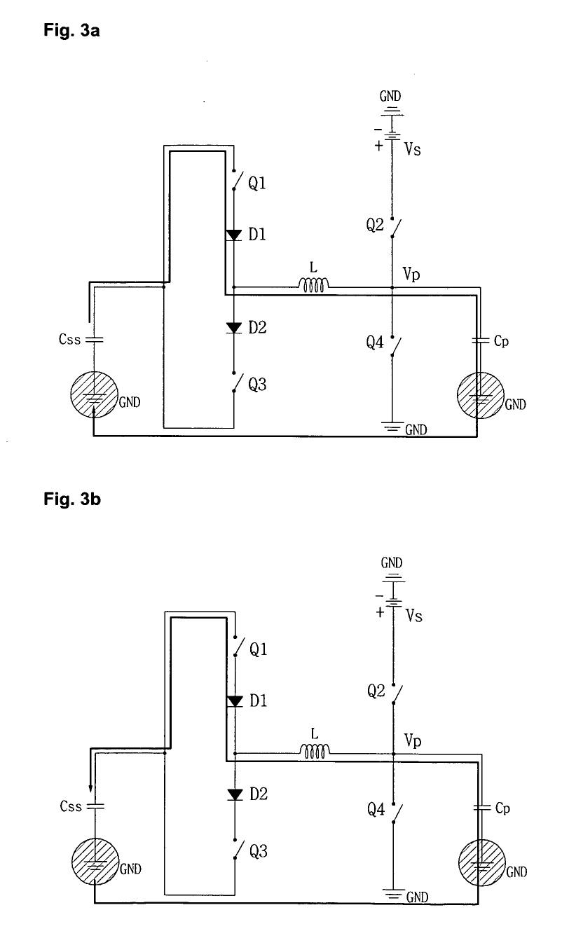

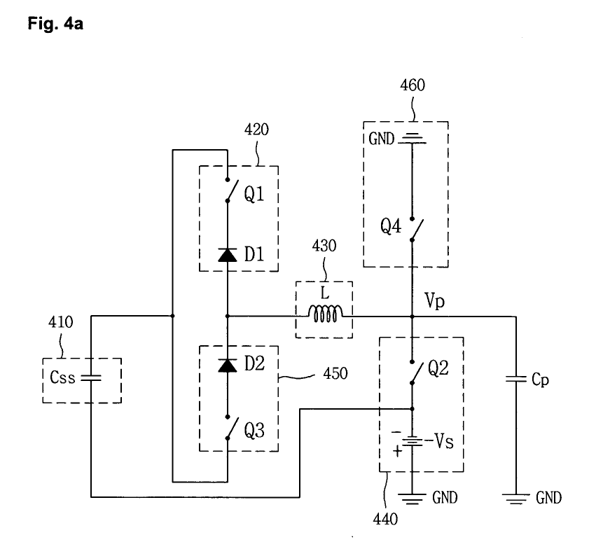

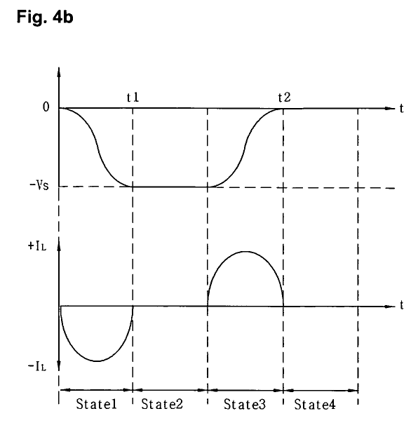

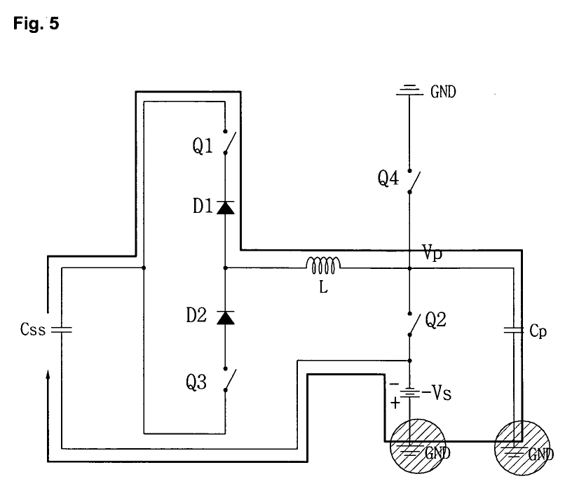

The energy storage unit 610 of the plasma display apparatus according to an embodiment of the present invention has one end connected to a common terminal of the voltage source for supplying the reference voltage (GND) and the fourth switch Q4. In the plasma display apparatus according to an embodiment of the present invention, the frame 140 of FIG. 1 is used as the voltage source for supplying the reference voltage. Therefore, the plasma display apparatus according to an embodiment of the present invention can form a smooth current loop through the frame 140 of FIG. 1 when supplying energy to or from the plasma display panel. As a smooth current loop is formed through the frame 140, circuit loss can be prohibited and an energy recovery ratio can also be enhanced.

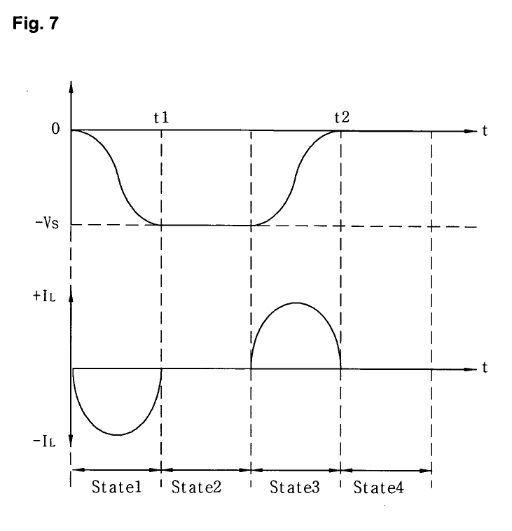

FIG. 7 shows a waveform of a sustain pulse depending on the operation of the plasma display apparatus according to an embodiment of the present invention.

In a first state (State1), the first switch Q1 is turned on, and the second switches Q2, the third switch Q3 and the fourth switch Q4 are turned off. Energy, which is stored in the capacitor Css and corresponds to the negative first voltage (−Vs/2), is supplied to the capacitance component Cp of the plasma display panel 590. The voltage (Vp) of the capacitance component Cp of the plasma display panel 590 falls up to the negative second voltage (−Vs) due to resonance of the inductor L and the capacitance component Cp of the plasma display panel 590. The current flowing through the inductor L becomes −IL since energy corresponding to the negative first voltage is supplied.

In a second state (State2), the first switch Q1 and the second switch Q2 are turned on, and the third switch Q3 and the fourth switch Q4 are turned off. Therefore, the voltage (Vp) of the capacitance component Cp of the plasma display panel 590 is kept to the negative second voltage (−Vs). That is, when the voltage (Vp) of the capacitance component Cp of the plasma display panel 590 becomes the negative second voltage (−Vs) due to LC resonance at t=t1, the negative second voltage (−Vs) is applied to the capacitance component Cp of the plasma display panel 590.

Thereafter, in a third state (State3), the third switch Q3 is turned on, and the first switch Q1, the second switch Q2 and the fourth switch Q4 are turned off. Energy stored in the capacitance component Cp of the plasma display panel is recovered by the capacitor Css. The voltage (Vp) of the capacitance component Cp of the plasma display panel 590 rises up to the reference voltage due to resonance of the inductor L and the capacitance component Cp of the plasma display panel 590. In the third state (State3), energy having a negative voltage characteristic is supplied from the capacitance component Cp of the plasma display panel 590 to the capacitor Css. Therefore, the current flowing through the inductor L becomes +IL since energy corresponding to the negative first voltage is recovered.

Lastly, in a fourth state (State4), the third switch Q3 and the fourth switch Q4 are turned on, and the first switch Q1 and the second switch Q2 are turned off. Therefore, the voltage (Vp) of the capacitance component Cp of the plasma display panel 590 is kept to the reference voltage.

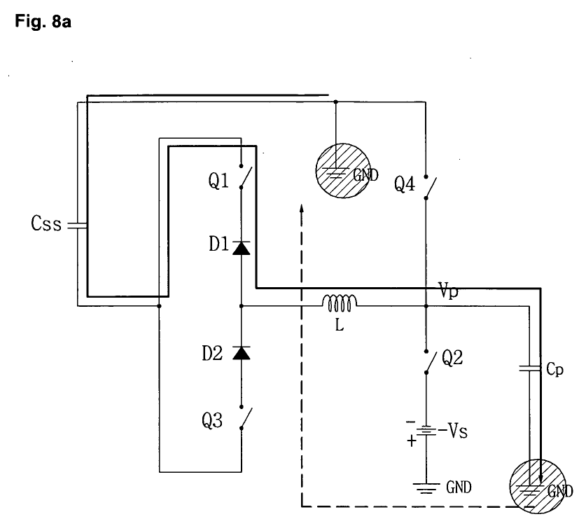

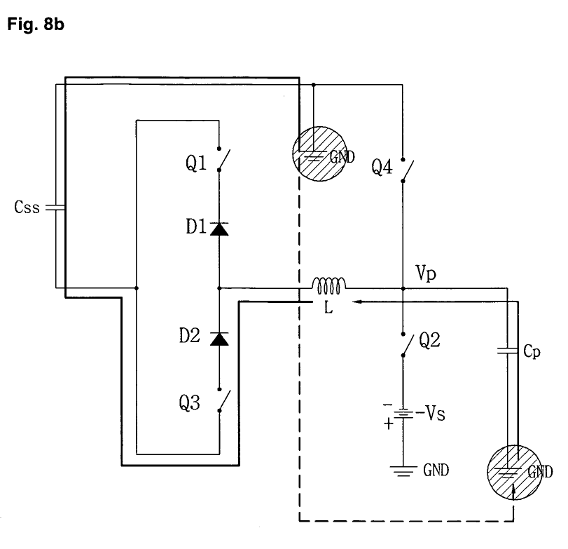

FIG. 8a shows a current loop in the first state of FIG. 7. As shown in FIG. 8a, in the first state (State1), energy that has been stored in the capacitor Css and corresponds to the negative first voltage (−Vs/2) is supplied to the capacitance component Cp of the plasma display panel 590. The current that has passed through the inductor L passes through the plasma display panel 590 and flows through the voltage source GND that supplies the reference voltage.

FIG. 8b shows a current loop in the third state of FIG. 7. As shown in FIG. 8b, in the third state (State3), energy that has been stored in the capacitance component Cp of the plasma display panel 590 is recovered by the capacitor Css. The current that has passed through the inductor L flows through the voltage source GND that supplies the reference voltage via the third switch Q3 and the capacitor Css.

In the first state (State1) and the third state (State3) the voltage source GND that supplies the reference voltage is the frame 140 of the plasma display apparatus shown in FIG. 1.

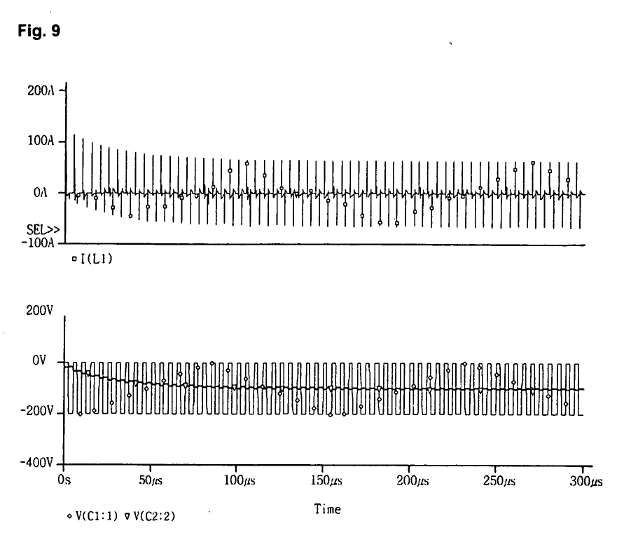

FIG. 9 shows a current waveform and a voltage waveform in the operation of the plasma display apparatus according to an embodiment of the present invention.

The voltage of the capacitance component of the plasma display panel has a negative sustain pulse as shown in the lower end of FIG. 9. The highest voltage level of the negative sustain pulse is 0V and the lowest voltage level of the negative sustain pulse is −200V. As indicated by a red line in the lower end of FIG. 9, the voltage of the capacitor gradually becomes −100V(=−200V/2=−Vs/2) from an initial voltage 0V as the number of a sustain discharge gradually increases.

Therefore, it can be seen that the simulation apparatus according to an embodiment of the present invention operates normally.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A driving apparatus of a plasma display panel comprising an electrode, comprising:
an energy storage unit connected to a voltage source that supplies a reference voltage, for supplying or recovering energy corresponding to a negative first voltage;
a path forming unit for supplying the energy corresponding to the negative first voltage from the energy storage unit to an electrode through resonance, or for recovering the energy corresponding to the negative first voltage from the electrode to the energy storage unit through resonance; and
a voltage application unit for applying a negative second voltage to the electrode after the energy corresponding to the negative first voltage is supplied and for applying the reference voltage to the electrode after the energy corresponding to the negative first voltage is recovered.

2. The driving apparatus as claimed in claim 1, wherein the reference voltage is a ground level voltage.

3. The driving apparatus as claimed in claim 1, wherein the negative first voltage is half of the negative second voltage.

4. The driving apparatus as claimed in claim 1, wherein the negative second voltage is a negative sustain voltage for sustaining a discharge.

5. The driving apparatus as claimed in claim 4, wherein the negative first voltage is half of the negative sustain voltage.

6. The driving apparatus as claimed in claim 1, wherein the energy storage unit comprises a capacitor for storing the energy, and the capacitor has one end connected to the voltage source that supplies the reference voltage, and the other end through which the energy is supplied or recovered.

7. The driving apparatus as claimed in claim 1, wherein the negative first voltage is −100V and the negative second voltage is −200V.

8. A plasma display apparatus comprising:
a plasma display panel comprising an electrode;
an energy storage unit connected to a voltage source that supplies a reference voltage, for supplying or recovering energy corresponding to a negative first voltage;
a path forming unit for supplying the energy corresponding to the negative first voltage from the energy storage unit to the plasma display panel through the electrode or for supplying the energy corresponding to the negative first voltage from the plasma display panel to the energy storage unit through the electrode; and
a voltage application unit for applying a negative second voltage to the electrode after energy corresponding to the negative first voltage is supplied and for applying the reference voltage to the electrode after energy corresponding to the negative first voltage is recovered.

9. The plasma display apparatus as claimed in claim 8, wherein the reference voltage is a ground level voltage.

10. The plasma display apparatus as claimed in claim 8, wherein the negative first voltage is half of the negative second voltage.

11. The plasma display apparatus as claimed in claim 8, wherein the negative second voltage is a negative sustain voltage for sustaining a discharge.

12. The plasma display apparatus as claimed in claim 11, wherein the negative first voltage is half of the negative sustain voltage.

13. The plasma display apparatus as claimed in claim 8, wherein the energy storage unit comprises a capacitor for storing the energy, and
the capacitor has one end connected to the voltage source that supplies the reference voltage, and the other end through which the energy is supplied or recovered.

14. The plasma display apparatus as claimed in claim 8, wherein the negative first voltage is −100V and the negative second voltage is −200V.

15. The plasma display apparatus as claimed in claim 8, wherein the voltage source that supplies the reference voltage is a frame supporting the plasma display panel.
